(19) United States
(12) Patent Application Publication
(10) Pub. No.: US 2012/0224709 A1
(43) Pub. Date: Sep. 6, 2012

(54) VOICE ACTIVATION SYSTEM AND METHOD AND COMMUNICATION SYSTEM AND METHOD USING THE SAME

(75) Inventors: Natan Keddem, South Easton, MA (US); Nicholas J. Cannata, Sutton, MA (US)

(73) Assignee: DAVID CLARK COMPANY INCORPORATED, Worcester, MA (US)

(21) Appl. No.: 13/410,731

(22) Filed: Mar. 2, 2012

Related U.S. Application Data
(60) Provisional application No. 61/448,746, filed on Mar. 3, 2011.

(51) Int. Cl. G08B 21/00; H04R 1/10

(52) U.S. Cl. 381/74; 340/660

(57) ABSTRACT

A communication system and a voice activation system and method for the communication system include a headset and a microphone. The voice activation system includes an adjustable first input voltage and a second input voltage. A controller compares the adjustable first input voltage and the second input voltage and generates an alert indicating an adjustment to the adjustable first input voltage.

### CROSS REFERENCE TO RELATED APPLICATION

This U.S. nonprovisional patent application claims the benefit of U.S. Provisional Patent Application No. 61/448,746, filed in the U.S. Patent and Trademark Office on Mar. 3, 2011, the entire contents of which are incorporated herein by reference.

### BACKGROUND

1. Technical Field

The present inventive concept is related to a communication system, such as a wireless intercom system or aviation headset communication system, having an adjustable voice activation (VOX) system and method which reduces or eliminates background noise picked up by a microphone while providing voice communications.

2. Discussion of the Related Art

A communication system, such as a wireless intercom system or an aviation headset communication system, typically includes a headset for providing audio output to a user. The headset is typically coupled to a microphone for receiving audio input from the user. The audio output provided by the headset can be generated locally, i.e., by the local user, or remotely by other users and transmitted to the local user's headset. The audio input received by the microphone can be transmitted to other users headsets or can be processed and presented as audio output in the local user's headset.

To limit the amount of sound received by the user, it desirable that communication from one user to another be activated by the voice of the speaking user. When a user is not speaking, that is, when the user is not providing any voice input to his/her microphone, it is desirable that the user's system not transmit any signal to the other user's headsets. This voice activation feature (VOX) requires that the sound entering the microphone exceed a certain preset threshold to activate the local headset for transmission to other users headsets. The threshold is typically set such that background noise does not exceed the threshold. In settings in which the background noise is variable, such as in the aviation setting, it is desirable that the threshold for voice activation be adjustable. This is typically accomplished by a knob-adjustable potentiometer accessible by the user.

In these user-adjustable voice activation (VOX) systems, the user typically turns the knob until the background noise can no longer be heard in the local headset. This approach is inaccurate because of various factors such as time delays in the electronic headset circuitry and variations in the background noise level, resulting in a threshold setting that is either higher or lower than that desired by the user.

### SUMMARY

In accordance with an aspect of the inventive concept, a voice activation system includes an adjustable first input voltage, a second input voltage, and a controller. The controller compares the adjustable first input voltage and the second input voltage and generates an alert indicating an adjustment to the adjustable first input voltage.

In one exemplary embodiment, the alert comprises an audible alert.

In one exemplary embodiment the alert comprises a visual alert. In another exemplary embodiment, the visual alert comprises a light.

In accordance with another aspect of the inventive concept, a communication system includes a headset, a microphone and a voice activation system. The voice activation system includes an adjustable first input voltage, a second input voltage, and a controller. The controller compares the adjustable first input voltage and the second input voltage and generates an alert indicating an adjustment to the adjustable first input voltage.

In one exemplary embodiment, the alert comprises an audible alert.

In one exemplary embodiment, rein the alert comprises a visual alert. In another embodiment, the visual alert comprises a light.

In accordance with another aspect of the inventive concept, a method of providing voice activation in a communication system includes comparing an adjustable first input voltage and a second input voltage and generating an alert indicating an adjustment to the adjustable first input voltage.

In one exemplary embodiment, the alert comprises an audible alert.

In one exemplary embodiment, the alert comprises a visual alert. In one exemplary embodiment, the visual alert comprises a light.

### BRIEF DESCRIPTION OF THE DRAWINGS

The foregoing and other features and advantages of the inventive concept will be apparent from the more particular description of preferred embodiments of the inventive concept, as illustrated in the accompanying drawings in which like reference characters refer to the same parts throughout the different views. The drawings are not necessarily to scale, emphasis instead being placed upon illustrating the principles of the inventive concept.

FIG. 1 contains a schematic block diagram of a communication system, in accordance with an exemplary embodiment of the present inventive concept.

FIG. 2 contains a schematic functional block diagram of a voice activation system, in accordance with an exemplary embodiment of the present inventive concept.

FIG. 3 contains a schematic functional block diagram of a controller of the voice activation system of FIG. 2, in accordance with an exemplary embodiment of the present inventive concept.

FIG. 4 contains a logical flow diagram illustrating the operation of the voice activation system, in accordance with an exemplary embodiment of the present inventive concept.

FIG. 5 contains a logical flow and functional block diagram illustrating the VOX operation of the voice activation system and method of FIG. 4, in accordance with an exemplary embodiment of the inventive concept.

FIG. 6 contains a logical flow and functional block diagram illustrating the VOX helper or VOX assist operation of the voice activation system and method of FIG. 4, in accordance with an exemplary embodiment of the inventive concept.

### DETAILED DESCRIPTION

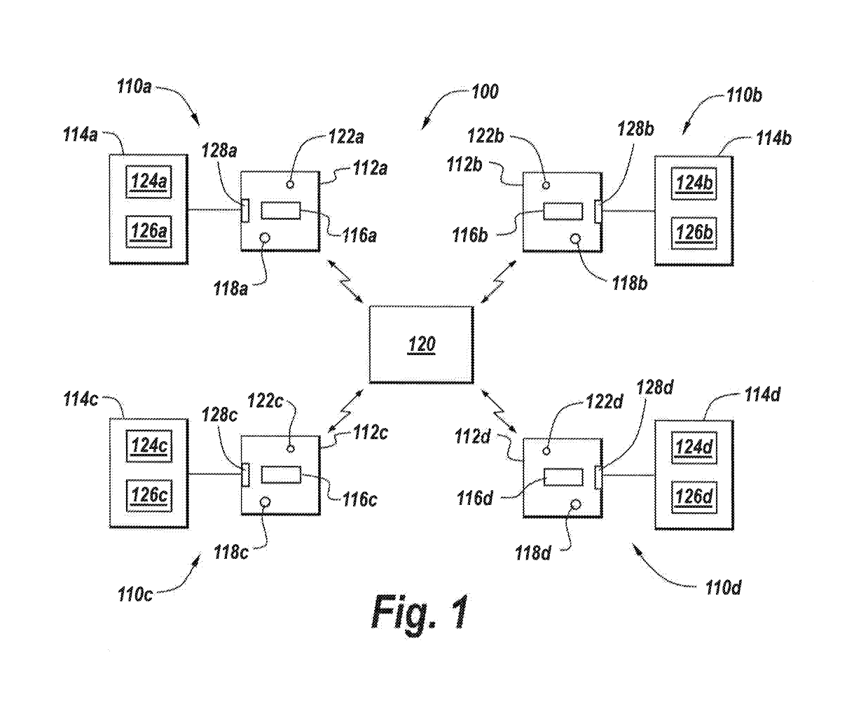

FIG. 1 contains a schematic block diagram of a communication system 100, in accordance with an exemplary embodiment of the present inventive concept. The system 100 illustrated in FIG. 1 is a wireless intercom system, which is described herein for the purpose of illustrating the inventive concept by way of example. It will be understood that the inventive concept is applicable to other types of communication systems, including for example, aviation communication systems using aviation headsets. In the exemplary embodiment illustrated in FIG. 1, the wireless intercom system 100 includes multiple local user stations 110, identified in FIG. 1 as 110a, 110b, 110c and 110d. The user stations 110 communicate wirelessly with each other via a wireless base station 120.

In some exemplary embodiments, each user station 110 can include a wireless communication station 112 coupled to a headset assembly 114. In some particular exemplary embodiments, each wireless communication station 112 can be, for example, a U9910-BSW Wireless Belt Station or similar device, and each headset assembly 114 can be, for example, an H9900-series headset or similar device, both manufactured and sold by David Clark Company Incorporated of Worcester, Mass., USA. Also, in some particular exemplary embodiments, the wireless base station 120 can be, for example, a U9911-BSC Controller Belt Station or a U9900-series gateway or similar device, both manufactured and sold by David Clark Company Incorporated of Worcester, Mass., USA.

Referring to FIG. 1, each communication station 112 can include electronic circuitry 116 used to carry out the functions of the communication station 112 and the headset assembly 114. The electronic circuitry 116 can include one or more controllers, processors, electronic memories, interface circuits, buses, and other appropriate electronic devices. The communication station 112 can also include a VOX adjust control 118, e.g., a control knob, used to adjust the threshold activation level of the VOX feature of the system. The communication station 112 can also include one or more visual status indicators 122, such as a light-emitting diode (LED).

The headset assembly 114 can include an audio output 126 for providing audio to the user. The audio output 126 can be, for example, one or more headset speakers. The headset assembly 114 can also include a microphone 124 for providing user input. The headset assembly 114 can be connected to the communication station 112 at a headset connector 128.

The communication system 100 of the inventive concept includes a voice activation (VOX) system. The VOX system is intended to prevent background noise from being unintentionally picked up by the microphone 124 while detecting and allowing voice communications. The VOX adjust knob 118 is used by the user to control the threshold at which the microphone 124 becomes “hot,” that is, when the microphone 124 is active such that the local user as well as other remote users can hear the audio input at the local user's microphone 124, in some particular exemplary embodiments, as described below in detail, when the VOX adjust knob 118 is turned fully clockwise, the microphone 124 is off; when the VOX adjust knob 118 is turned fully counter-clockwise, the microphone 124 is “hot” or on; and when the VOX adjust knob 118 is turned between fully clockwise and fully counter-clockwise, the VOX system is enabled and activation of the microphone 124 is dependent upon the threshold set by the VOX adjust knob 118.

According to the inventive concept, to set the VOX threshold, the user moves to an area with a background noise level that is representative of the background noise level that is to be present during normal operation. The user does not allow other noise inputs to reach the microphone, i.e., the user refrains from speaking during the setting of the VOX threshold. The user turns the VOX control knob 118 fully counter-clockwise to turn the microphone on. At this time, according to the inventive concept, the system generates and transmits to the user's headset speakers a continuous tone, referred to herein as a VOX helper or VOX assist tone, to indicate that the VOX threshold is being adjusted and that the threshold that would eliminate the background noise has not been reached, i.e., in the presence of the current background noise, the microphone 124 will be on. The user then turns the VOX adjust knob 118 clockwise until the VOX helper or VOX assist tone is no longer being transmitted to the headset speakers. At this point, the VOX threshold is optimally set to eliminate activation of the microphone 124 by the current background noise environment.

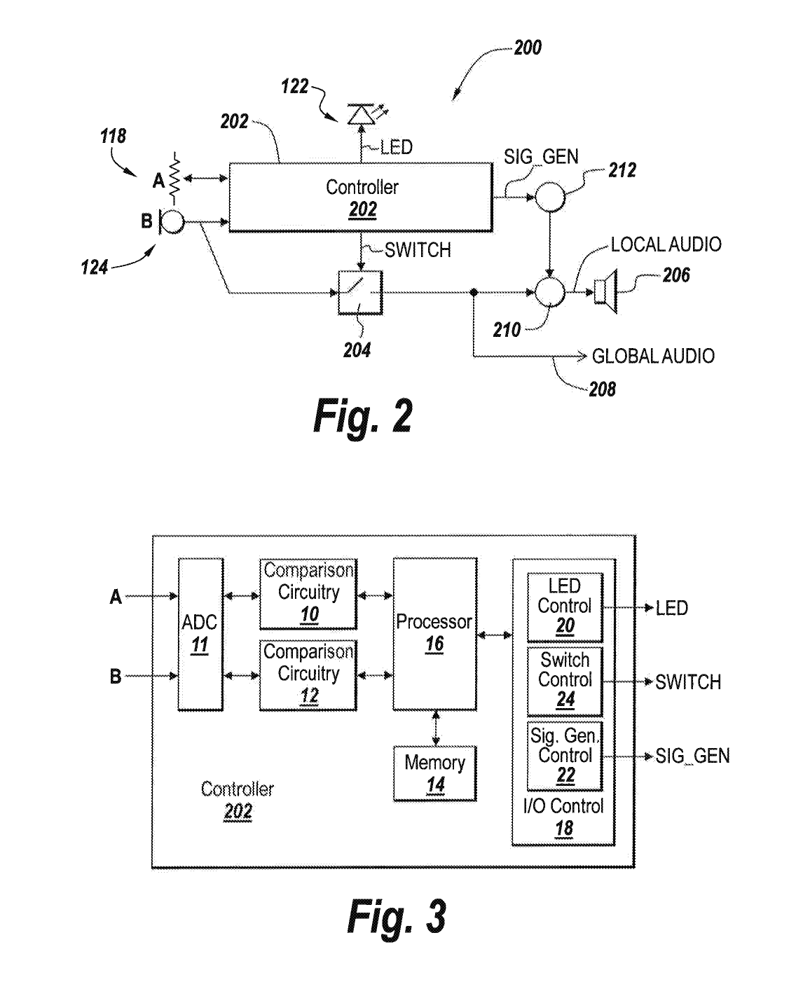

FIG. 2 is a schematic functional block diagram of a voice activation (VOX) system 200 in accordance with an exemplary embodiment of the present inventive concept. Voltage input A is a voltage input controlled via a potentiometer, namely, the VOX adjust knob 118. Voltage input B is a voltage input with a voltage induced via a microphone, such as the microphone 124 used as part of the headset assembly 114 of the communication system 100 of the inventive concept. A controller 202, which can be part of the electronics 116, inputs the two analog signals A and B and processes the signals to generate control signals to control the various other elements of the communication system 100, such as the system elements involved in the voice activation of the inventive concept. A light emitting diode (LED), such as the visual status indicator LED 122, is activated by the controller 202 for user feedback. The LED 122 is controlled by an LED control signal LED generated by the controller 202.

A switch 204 controls the flow of the audio signal from the microphone 124. When the switch 204 is closed, audio from the microphone 124 is passed to audio outputs 206 and 208 of the system. The audio output 206 generally refers to audio which is heard only by the local user. For example, the audio output 206, labeled LOCAL AUDIO, can be the speaker(s) in the user's own headset, i.e., sidetone. The audio output 208, referred to as GLOBAL AUDIO, is the output, i.e., audio signal, transmitted out of the local user station 110 to the user stations 110 of other users. The state of switch 204 is controlled by a switch control signal SWITCH generated by controller 202.

A signal generator 212, e.g., a sine wave signal source, can generate, for example, an audible tone under the control of a signal generator control signal SIG_GEN, which is generated by the controller 202. The audible tone can be forwarded to the signal summation point 210, where audio signals from the microphone 124 and the signal source 212 are combined. The tone can be, for example, the VOX helper or VOX assist tone according to the inventive concept used as user feedback in adjusting the VOX setting for the system, as described herein in detail. The combined audio signal is transferred from the summation point 210 to the local audio output 206, such that the local user can hear the microphone signal and the tone from the signal source 212.

The controller 202 sets a threshold at which the microphone 124 becomes “hot.” That is, controller 202 sets the threshold at which switch 204 is closed and the microphone 124 is turned on, such that audio from the microphone 124 is transmitted to both the local audio output 206 and the global audio output 208. The threshold is set by the position of the VOX adjust knob 118, which controls the voltage level of the potentiometer signal A. For example, when the knob 118 is set fully in the counter clockwise (CCW) direction, the threshold is set to its lowest level such that switch 204 is closed, i.e., the microphone 124 is always turned on. When the VOX adjust knob 118 is set fully in the clockwise (CW) direction, the threshold is set to its highest level such that the switch 204 is open, i.e., the microphone 124 is always turned off.

During normal VOX operation, the knob 118 is set somewhere between fully CCW and fully CW such that the threshold is set such that ambient background noise is below the threshold, but voice input from the user is above the threshold. As a result, when only background noise is present at the microphone 124, switch 204 is open, and the microphone 124 is turned off. However, when the user speaks, the signal level at the microphone 124 exceeds the threshold, and switch 204 is closed, such that audio at the microphone 124, i.e., the user's voice, is passed to the audio outputs 206 and 208. That is, the controller 202 sets the threshold so that background noise is not picked up by the microphone 124 and passed to the local user or other remote users.

FIG. 3 is a schematic block diagram of the controller 202 of the voice activation system of FIG. 2, according to an embodiment of the inventive concept. Referring to FIGS. 2 and 3, the controller 202 receives the analog voltage signals A and B from the VOX adjust potentiometer 118 and the microphone 124, respectively, and, in one embodiment, converts the received analog signals to digital signals using analog-to-digital conversion (ADC) circuitry 11. The controller 202 includes a processor 16 coupled to a memory 14, which operate together to control the various functions of the communication system 100 of the inventive concept, as described herein in detail. The controller 202 also includes first comparison circuitry 10 and second comparison circuitry 12. The first comparison circuitry 10 compares previous and present settings of the potentiometer signal A to determine whether the VOX adjust knob 118 has been moved, i.e., whether the user is attempting to adjust the VOX threshold. If the potentiometer voltage A has changed, then the processor 16 operates to place the system in VOX helper or VOX assist mode, in which the VOX threshold is adjusted. The second comparison circuitry 12 compares the voltage level of the signal B at the microphone 124 with the present threshold voltage to determine whether the switch 204 should be closed such that the signal B at the microphone 124 be will be forwarded to the audio outputs 206 and 208.

The controller 202 also includes input/output control and interface circuitry and functionality, generally indicated by reference numeral 18. The processor 16 and memory 14 generate control signals, including an LED control signal LED, a switch control signal SWITCH, and a signal generator control signal SIG_GEN, and forward the control signals via corresponding I/O processing and control circuitry to the LED 122, switch 204, and signal generator 212, respectively. Specifically, the LED control signal LED is forwarded via the LED control circuitry 20, the switch control signal SWUM is forwarded via the switch control circuitry 24, and the signal generator control signal SIG_GEN is forwarded via the signal generator control circuitry 22.

Referring to the block diagram of the controller 202 shown in FIG. 3, it is noted that the actual configuration of the circuitry can be different than that shown in the figure, without departing from the inventive concept. For example, the controller 202 is shown in FIG. 3 as including ADC circuitry 11 receiving analog signals A and B, converting the analog signals to digital signals and forwarding the converted digital signals to comparison circuits 10 and 12. It should be noted that this configuration is for illustration purposes only and should not be interpreted so as to limit the inventive concept to this configuration. For example, the ADC circuitry 11 may not be present, and the analog signals may be compared by the comparison circuitry 10 and 12, without their first being converted to digital signals. Alternatively, the ADC circuitry 11 may be present, but it may be after the comparison circuitry 10 and/or 12. That is, the ADC circuitry 11 may convert the results of the comparison(s) to digital signals. Alternatively, there may actually be no separate comparison circuitry at all, and the comparison may be carried out on the outputs of the ADC circuitry 11 directly by the processor 16 in software. Similarly, the I/O control and interface circuitry is illustrated as containing the LED control circuitry 20, the switch control circuitry 24 and the signal generator control circuitry 22. It should be noted that these blocks of the block diagram of FIG. 3 are used to represent general functionality and structure of the controller 202 and should not be construed as limiting the functionality or structure of the controller 202 to any particular configuration. For example, the control signals LED, SWITCH and SIG_GEN may be generated and forwarded by the processor 16 in conjunction with the associated memory 14, without any intervening I/O control and interface circuitry 18.

In the VOX helper or VOX assist mode, i.e., when the user is adjusting the VOX threshold, in accordance with embodiments of the inventive concept, the LED control signal is used to control the LED 122 to provide visual feedback to the user while he/she is adjusting the VOX threshold. For example, in one particular exemplary embodiment, the LED control signal LED can be generated by the processor 16 to activate the LED 122 to light either steady green or steady red, depending on whether the VOX threshold has been correctly set. Specifically, the LED control signal LED can set the LED 122 to illuminate steady green while the signal B at the microphone 124 exceeds the threshold to indicate that the microphone 124 is on, and to change to illuminate steady red when the VOX threshold has been adjusted such that the signal B at the microphone 124 no longer exceeds the threshold and the microphone 124 is off, thus indicating to the user that the VOX threshold has been adjusted to block background noise from the audio outputs 206 and 208.

In the VOX helper or VOX assist mode, in accordance with embodiments of the inventive concept, the signal generator control signal SIG_GEN can be used to provide audio feedback to the user while he/she is adjusting the VOX threshold to assist the user in adjusting the VOX threshold. When the user is adjusting the VOX threshold, in accordance with embodiments of the inventive concept, the signal generator control signal SIG_GEN is selectively activated such that, when the signal SIG_GEN is active, a signal such as a sine wave tone signal is output by the signal generator 212 and is applied to the signal summing circuitry 210. When the signal SIG_GEN is not active, the signal generator 212 does not provide the tone signal. The summing circuitry 210 combines the tone signal from the signal generator 212 with the signal B from the microphone 124 and forwards the combined signal to the local audio output 206, such that the tone, when present, can be heard by the local user. Whether the tone is activated by the signal SIG_GEN can be associated with the comparison of the signal B at the microphone 124 and the VOX threshold. That is, the active/inactive state of the SIG_GEN signal can be set based on whether the signal B at the microphone 124 exceeds the VOX threshold while the user is adjusting the VOX threshold. For example, in one particular exemplary embodiment, during VOX helper or VOX assist mode, the control signal SIG_GEN can be generated by the processor 16 to provide the tone to the user while the signal B at the microphone 124 exceeds the threshold, and not to provide the tone to the user when the VOX threshold has been adjusted such that the signal B at the microphone 124 no longer exceeds the threshold, thus indicating to the user that the VOX threshold has been adjusted to block background noise.

Thus, in the communication system and method according to embodiments of the inventive concept, when changes to the VOX adjust knob 118 are detected, the threshold assistance mode, also referred to herein as the VOX helper or VOX assist mode, is initiated to allow the user to set the VOX threshold. During this adjustment, the user refrains from speaking and prevents noise other than background nose from reaching the microphone 124. While the VOX adjust knob 118 is rotated, if the noise at the microphone 124 exceeds the threshold, the microphone 124 is on, i.e., “hot,” and the audio at the microphone 124 is received at the local audio output 206, i.e., sidetone. At the same time, the signal generator 212 provides the tone at the audio output 206, i.e., sidetone. Also, the LED 122 is set to illuminate steady green, for example, to indicate that the microphone 124 is on. As the user continues to rotate the VOX adjust knob 118, the tone and LED conditions remain the same until the VOX adjust knob 118 is sufficiently rotated to cause the threshold to exceed the noise at the microphone 124. At that point, the tone is no longer provided to the user. In addition, the state of the LED 122 changes to, for example, steady red, to indicate that the microphone 124 is off. These indications to the user advise the user that the VOX threshold is properly set to block background nose from reaching the local and global audio outputs 206 and 208.

During normal operation of the communication system 100 with VOX properly set and operational, when the user speaks into the microphone 124, the microphone 124 is on, i.e., switch 204 is closed, in response to the user's voice. A delay, referred to herein as a “hang time” or “VOX hang time” delay, is set from the time the noise entering the microphone 124 drops below the threshold to the time the microphone 124 is shut off, i.e., switch 204 is opened. This hang time delay is used to eliminate switching of the microphone 124 between the on and off states during brief pauses in the user's speaking pattern. In one particular exemplary embodiment, the hang time delay is set to approximately 1.5 seconds. When VOX helper or VOX assist mode is initiated, this hang time delay is substantially reduced or eliminated so that the setting of the VOX threshold can be accomplished precisely, i.e., without the error that would be introduced by the hang time delay after the adjustment of the VOX knob caused the threshold to exceed the nose level at the microphone 124.

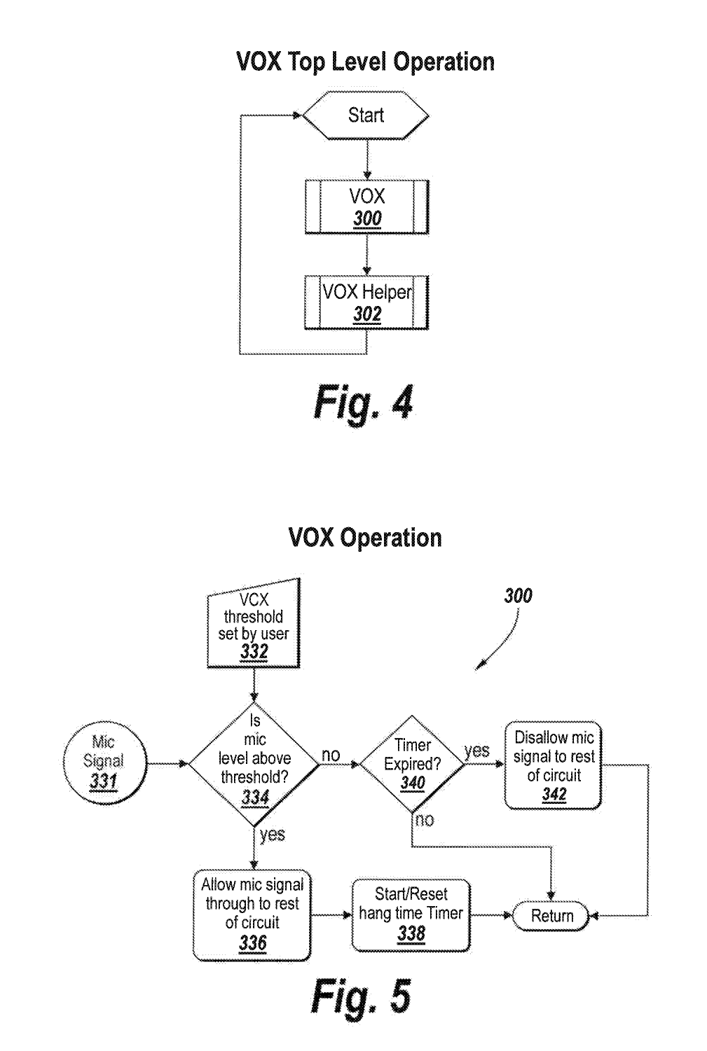

FIGS. 4-6 are logical flow and functional block diagrams illustrating the operation of the communication system and method of the inventive concept, according to some exemplary embodiments. The operations and functions illustrated in FIGS. 4-6 are controlled by controller 202 illustrated in FIGS. 2 and 3, and, more specifically, by the processor 16 and memory circuitry 14 in the controller 202, as illustrated and described in detail above in connection with FIGS. 2 and 3.

FIG. 4 is a logical flow diagram illustrating the operation of the voice activation system and method in accordance with an exemplary embodiment of the present inventive concept. FIG. 4 illustrates the top-level operation of the voice activation system and method of FIG. 2. The voice activation system and method include the VOX operation 300, which is the normal operational mode of the system during normal use for communication among multiple users, and the VOX helper or VOX assist operation 302, during which the local user is adjusting the VOX threshold for his/her local system.

FIG. 5 is a logical flow and functional block diagram illustrating the VOX operation 300, i.e., normal mode of operation, of the voice activation system and method of FIG. 4. Referring to FIG. 5, in decision step 334, two inputs, namely, the VOX threshold 332 set by the user and the microphone signal 331, are compared. In step 334, if the microphone level is above the threshold, the microphone signal is allowed through the rest of the circuit, that is, switch 204 of FIG. 2 is closed, as illustrated in step 336. In step 338, the hang time timer is started/reset. As noted above, the hang time timer can be started/reset to approximately 1.5 seconds. Flow then returns to decision step 334, where the level at the microphone 124 is continuously compared to the VOX threshold. In decision step 334, if the microphone level is not above the threshold, a determination is made as to whether the hang time has expired in step 340. If the controller 202 determines that the timer has expired, then, in step 342, the microphone signal is disallowed from the rest of the circuit, that is, switch 204 of FIG. 2 is opened, and the microphone 124 is shut off. Flow then returns to decision step 334, where the system again continuously monitors the level of the microphone 124 as compared to the VOX threshold. If in decision step 340 it is determined that the timer has not yet expired, then no action is taken. In this case, flow again returns to decision step 334, where the system continues to wait until either the microphone level exceeds the VOX threshold (step 334) or the hang time expires (step 340).

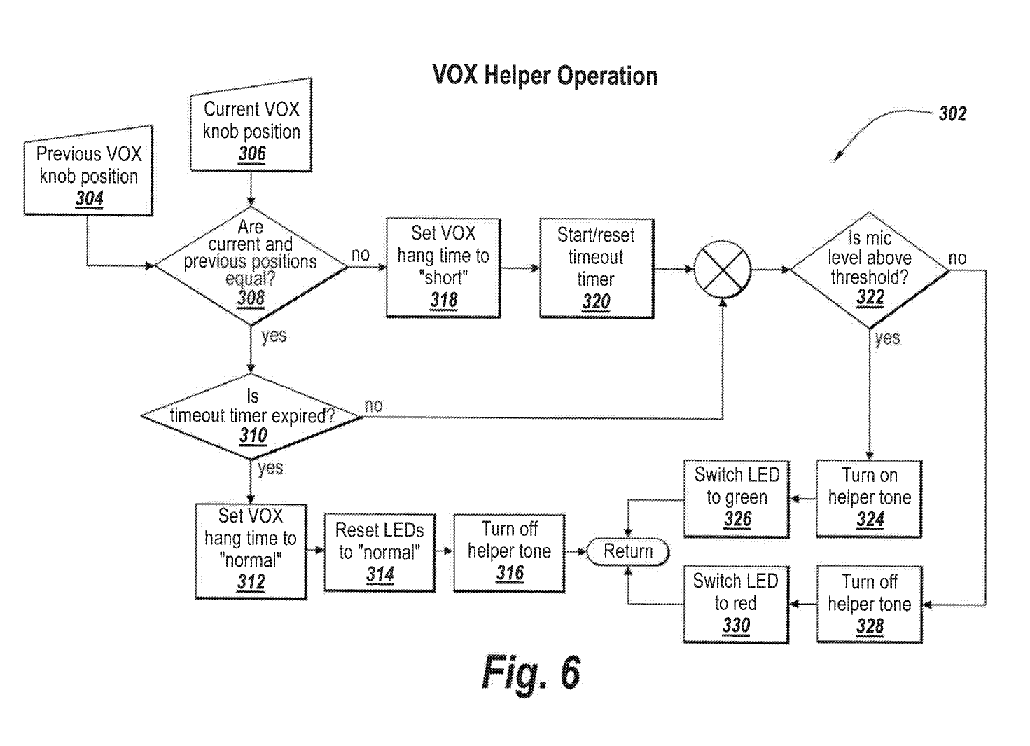

FIG. 6 is a logical flow and functional block diagram illustrating the VOX helper or VOX assist operation 302 of the voice activation system and method of FIG. 4. Referring to FIG. 6, in decision step 308, it is determined whether the VOX adjust knob 118 is being turned, i.e., whether the VOX threshold is being adjusted. This determination is made by comparing a previous VOX adjust knob position 304 to a current VOX adjust knob position 306. If the current and previous positions are not equal, then the VOX helper or VOX assist mode is initiated or continued. Accordingly, in step 318, the VOX hang time timer is set to the “short” mode, in which the time of the hang time timer is substantially reduced from the normal time, e.g., 1.5 seconds, to a shorter time, for example, approximately 0.5 second. In the VOX helper or VOX assist mode, an additional timeout timer is started/reset in step 320. This additional timeout time is used to end the VOX helper or VOX assist mode a certain predetermined time after the VOX adjust knob 118 is no longer being turned. In one particular exemplary embodiment, the time of this timeout timer can be set to, for example, approximately five seconds. In decision step 322, it is determined whether the microphone signal level exceeds the VOX threshold. If it does, then, in step 324, the helper tone from the signal generator 212 is activated by the SIG_GEN control signal and is routed to the summing circuitry 210 and then to the local audio output 206, such that the user adjusting the VOX threshold can hear the helper tone, in step 326, the LED control signal LED sets the LED 122 to a setting, such as, for example, steady green, to indicate that the microphone 124 is on in the VOX helper or VOX assist mode. At this point, the flow returns to decision step 308, where the VOX adjust knob 118 is monitored for movement. Returning to step 322, if in that step it is determined that the microphone level is not above the threshold, then in step 328, the SIG_GEN control signal is deactivated to turn off the helper tone, and, in step 330, the LED control signal changes state to change the LED 122 to another mode, such as steady red. These two changes in helper tone and LED condition indicate to the user that the VOX threshold has been adjusted to a point at which the noise at the microphone 124 is not being passed to the audio outputs 206 and 208. Flow of the method then returns to decision step 308 to continue to monitor the VOX adjust knob 118.

Returning to decision step 308, when the previous and current VOX adjust knob positions are the same, then either the user has stopped turning the knob 118 or has not recently turned the knob 118. In decision step 310, a determination is made as to whether the VOX helper or VOX assist mode timeout timer has expired. If not, flow continues to decision step 322, where the level of the microphone 124 continues to be compared to the threshold. This loop continues until the microphone level is not above the threshold (step 322) and the timeout timer has expired (step 310). In decision step 310, when the timeout timer expires, operation of the communication system and method returns to the normal VOX operation mode 300, as described above in detail in connection with FIG. 5. To that end, the VOX hang time timer is set to the normal value, e.g., approximately 1.5 seconds, in step 312, the LED 122 is set to the normal mode in step 314, and the helper tone is turned off in step 316, if it has not already been turned off. Flow then returns to decision step 308, where the VOX adjust knob 118 is again monitored for movement.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

For example, the inventive concept is described herein in terms of an exemplary wireless intercom system 100 illustrated in FIG. 1. Such a system is described herein for the purpose of illustrating the inventive concept by way of example. It will be understood that the voice activation (VOX) assist or helper system and method of the inventive concept described herein is applicable to other types of communication systems, including for example, aviation communication systems using aviation headsets, or, in general, any type of communication system using a microphone to receive input from a user and any type of audio speaker for providing audio output to the user.

Also, the inventive concept is described herein using a VOX adjust knob (118) in the form of a potentiometer used to vary a threshold voltage for comparison to a voltage level in a signal received from a microphone 124. It will be understood that various approaches can be used to vary a threshold for comparison to a value received from a microphone. For example, actuators such as pushbuttons can be used to provide a threshold number for comparison, instead of a potentiometer used to provide a threshold voltage. The VOX assist or helper approach of the present inventive concept is applicable to any such variation in how the VOX threshold is set by the user.

1. A voice activation system, comprising:
an adjustable first input voltage;
a second input voltage; and
a controller comparing the adjustable first input voltage and the second input voltage and generating an alert indicating an adjustment to the adjustable first input voltage.

2. The voice activation system of claim 1, wherein the alert comprises an audible alert.

3. The voice activation system of claim 1, wherein the alert comprises a visual alert.

4. The voice activation system of claim 3, wherein the visual alert comprises a light.

5. A communication system, comprising:
a headset;
a microphone;
a voice activation system, comprising:
an adjustable first input voltage;
a second input voltage; and
a controller comparing the adjustable first input voltage and the second input voltage and generating an alert indicating an adjustment to the adjustable first input voltage and.

6. The communication system of claim 5, wherein the alert comprises an audible alert.

7. The communication system of claim 5, wherein the alert comprises a visual alert.

8. The communication system of claim 7, wherein the visual alert comprises a light.

9. A method of providing voice activation in a communication system, comprising:
comparing an adjustable first input voltage and a second input voltage; and
generating an alert indicating an adjustment to the adjustable first input voltage.

10. The method of claim 9, wherein the alert comprises an audible alert.

11. The method of claim 9, wherein the alert comprises a visual alert.

12. The method of claim 11, wherein the visual alert comprises a light.
